(19) United States
(12) Patent Application Publication
(10) Pub. No.: US 2025/0042459 A1
(43) Pub. Date: Feb. 6, 2025

(54) FOLDING TRAILER

(71) Applicant: Qingyuan Wu, Jinhua (CN)

(72) Inventor: Qingyuan Wu, Jinhua (CN)

(21) Appl. No.: 18/468,572

(22) Filed: Sep. 15, 2023

(30) Foreign Application Priority Data
Aug. 1, 2023 (CN) 202322049648.5

(51) Int. Cl. B62B 3/02; B62B 5/06

(52) U.S. Cl. CPC B62B 3/025; B62B 5/067

(57) ABSTRACT

The invention relates to the trailer and particularly serves for a folding trailer, comprising a rod assembly, four vertical pipes, a linkage sliding sleeve, a left-right folding assembly and a front-back folding assembly, the left and right folding assemblies include six cross tubes, and the front-rear folding assemblies include two cross straight tubes and two cross bend tubes, to ensure that the intersections of the second and third cross tubes, as well as the fourth and fifth cross tubes, are shifted down, as is the intersection of the second cross elbow and the second cross straight tube; The highest point of the constricted second, third, fourth, and fifth crossovers shall be lower than the horizontal line of the vertex-angle fastener, which ensures the highest point of the contracted folding trailer is level with the highest point of the vertex angle fixing piece not to raise the contracted height.

### CROSS-REFERENCE TO RELATED APPLICATIONS

This application claims priority of Chinese Patent Application No. 202322049648.5, filed on Aug. 1, 2023, the entire contents of which are incorporated herein by reference.

### TECHNOLOGY FIELD

The present application relates to the field of trailers, in particular to folding and gathering trailers.

### BACKGROUND TECHNOLOGY

In daily life and production, it is often needed to carry luggage or goods, such as the process of handling often used to trailer tools. Trailers are widely used in carrying things because of their convenient and labor-saving characteristics.

For the purpose of saving space, it is a hot spot in the industry to receive the trailers in the non-use state, but the supporting rod of the trailers side is mostly fixed on the vertical rod and adopts the way of rotating receiving, when receiving the support bar from oblique cross into vertical cross, and it will inevitably lead to the receiving height increases, additional occupation receiving space.

The technical problem to be solved in this application is: How to make the trailer will not be raised after storage and take up additional storage space.

### CONTENTS OF APPLICATION

For the purpose of overcoming the deficiency of the prior art, the object of the present application is to provide a converging folding trailer which can not be raised after being folded.

The technical proposal adopted in this application is: a converging folding trailer, which comprises a standing rod assembly comprising a first fixed vertical pipe, a second fixed vertical pipe, a third fixed vertical pipe and a fourth fixed vertical pipe, the vertical rod assembly also comprises a top angle fixing piece which is respectively fixed on the top of four vertical pipes and a linkage sliding sleeve which is glibly connected with four vertical rods respectively

A left and right folding assembly is arranged between the second and the fourth fixed vertical pipes and between the first and the third fixed vertical pipes, the front and back folding components are arranged between the first and second fixed vertical tubes and between the third and fourth fixed vertical tubes;

The left-right folding assembly comprises a first cross tube rotationally matched with the top angle fixing piece and a sixth cross tube, the left and right folding assembly also comprises a second cross tube and a fifth cross tube rotationally matched with the linkage sliding sleeve respectively, the left-right Folding Assembly also comprises a third cross tube and a fourth cross tube rotationally matched with the first cross tube and the sixth cross tube respectively;

The front and rear folding assemblies include a first cross bend pipe and a first cross straight pipe rotationally matched with the top angle fixing piece, respectively, the front and rear folding components also include a second cross bend pipe and a second cross straight pipe which are rotationally matched with the linkage sliding sleeve respectively.

In some implementations, the first cross tube is connected with the second cross tube, the fourth cross tube and the sixth cross tube respectively by a rotating shaft, and the second cross tube and the third cross tube are connected by a rotating shaft, the third cross tube and the sixth cross tube are connected by a rotating shaft, the fourth cross tube and the fifth cross tube are connected by a rotating shaft, and the fifth cross tube and the sixth cross tube are connected by a rotating shaft.

In some implementations, the first crossovers and the second crossovers are connected by a rotating shaft, and the first crossovers and the second crossovers are connected by a rotating shaft, the first Cross Elbow and the first cross straight pipe are connected by a rotating shaft, and the second cross elbow and the second cross straight pipe are connected by a rotating shaft.

In some implementations, the rod assembly further comprises a bottom angle fixing member which is respectively fixed to the bottom of four vertical tubes, and the bottom of the rod assembly is provided with a bottom support assembly, the bottom supporting assembly comprises a first bottom connecting pipe, a second bottom connecting pipe, a third bottom connecting pipe and a fourth bottom connecting pipe which are in X-shape respectively and rotationally matched with the four bottom angle fixing pieces respectively, the cross center of the first bottom connecting pipe, the second bottom connecting pipe, the third bottom connecting pipe and the fourth bottom connecting pipe is also provided with a bottom connecting piece rotationally matched with the four bottom connecting pipes respectively.

In some implementations, a handle assembly is also provided between the first and second fixed risers, and the handle assembly includes a shrink sleeve at the bottom of the first and second fixed risers, respectively, the shrink sleeve is provided with two cross-sections, and the two cross-sections of the shrink sleeve are provided with a fixed rod sleeve which is rotationally matched with the two, the top of the third telescopic cylinder is provided with a second telescopic cylinder matched with the telescopic cylinder, and the top of the second telescopic cylinder is provided with a first telescopic cylinder matched with the telescopic cylinder, and a handle is fixed on the top of the first telescopic cylinder.

In some implementations, a wheel assembly is provided at the bottom of the vertical rod assembly, the wheel assembly comprises wheels at the bottom of the first fixed riser, the second fixed riser, the third fixed riser and the fourth fixed riser, respectively, the wheel at the bottom of the first and second fixed vertical tubes and the joint of the two vertical tubes are respectively provided with a universal wheel fork, the wheels at the bottom of the third and fourth fixed vertical tubes are connected with the two vertical tubes respectively to be provided with directional wheel forks.

In some implementations, the bottom attachment rises when the folding trailer shrinks, the side of the first bottom connecting pipe, the second bottom connecting pipe, the third bottom connecting pipe and the fourth bottom connecting pipe near the bottom connecting piece rises with the bottom connecting piece, the first bottom connecting pipe, the second bottom connecting pipe, the third bottom connecting pipe and the fourth bottom connecting pipe are close to one side of the bottom angle fixing piece to the direction of the bottom connecting piece.

In some implementations, when the folding trailer shrinks, four of the linkage sliding sleeves simultaneously descend, the included angles on both sides of the first cross tube and the second cross tube and on both sides of the fifth cross tube and the sixth cross tube increase, the angle between the lower end of the second crossing tube and the third crossing tube and the angle between the fourth crossing tube and the fifth crossing tube are reduced, the included angle of the lower end of the third crossing tube and the fourth crossing tube and the included angle of the upper end of the first crossing tube and the sixth crossing tube are reduced.

In some implementations, the angle on both sides of the first Cross Bend and the second Cross Bend, and the angle on both sides of the first cross straight and the second cross straight tubes, are increased when the folding trailer shrinks, the included angle of the lower end of the first cross elbow and the first cross straight pipe and the included angle of the upper end of the second cross elbow and the second cross straight pipe are reduced.

In some implementations, when the folding trailer shrinks, the fixed rod sleeve rises and the angle between the lower ends of the two shrinking sleeves decreases.

The beneficial effect of this application is that when the converging folding trailer shrinks, the four linkage sliding sleeves drop synchronously, to ensure that the crossing points of the second and third cross tubes and the crossing points of the fourth and fifth cross tubes are moved down, and at the same time, the crossing points of the second cross bend tube and cross straight tube are also moved down, while fixing the top angle fixing piece, the highest point of the contracted second cross tube, the third cross tube, the fourth cross tube and the fifth cross tube can not be higher than the horizontal line of the top angle fixing piece, in order to ensure that the highest point of the converged folding trailer after shrinking is level with the highest point of the vertex angle fixing piece, so as to achieve the effect of not raising the height after shrinking and save space, the utility model can be conveniently placed in the space of the trunk of the vehicle, the space of the storage room and the remaining space to be stored, and the shrinking process is convenient and rapid, and the single person can complete the operation.

### NOTE WITH DRAWINGS AND FIGURES

FIG. 1 is the three-dimensional structure schematic diagram of the deployment state of the application;

FIG. 2 is the main view structure of the open state of the application

FIG. 3 is the diagram of the left-view structure of the deployment state of the application;

FIG. 4 is the open state of the application

FIG. 5 is the schematic diagram of the principal structure in the semi-contraction state of the application;

FIG. 6 shows the full-contraction principal structure of the application;

FIG. 7 is the schematic diagram of the left-view structure in the semi-contraction state of this application;

FIG. 8 shows the left-viewing structure of the application in full-contraction state.

Drawing: 1, handle assembly; 11, handle; 12, first telescopic barrel; 13, second telescopic barrel; 14, third telescopic barrel; 15, shrink sleeve; 16, fixed rod sleeve; 15, shrink sleeve; 15, shrink sleeve; 15, shrink sleeve
2. Vertical rod assembly; 21. First fixed vertical tube; 22. Second fixed vertical tube; 23. Third fixed vertical tube; 24. Fourth fixed vertical tube; 25. Top angle fixing piece; 26. Linkage sliding sleeve; 27. Bottom angle fixing piece;
3. Left-right folding assembly; (31) first cross tube; (32) second cross tube; (33) third cross tube; (34) fourth cross tube; (35) fifth cross tube; (36) sixth cross tube; (36) left-right folding assembly; (3) Left-right folding assembly; (3) Left-right folding assembly; (3) Left-right folding assembly; (3) left-right folding assembly; (3) Left-right folding assembly; (3) Left-right folding assembly; (3) Left-right folding
4. Front and rear folding assembly; 41. First Cross Bend; 42. First cross straight tube; 43. Second Cross Bend; 44. Second cross straight tube;
5. Wheel assembly; 51, universal fork; 52, directional fork; 53, wheel;
6. Bottom support assembly; 61. first bottom connector; 62. second bottom connector; 63. third bottom connector; 64. fourth bottom connector; 65. bottom connector.

### PRACTICAL IMPLEMENTATION

The following is a clear and complete description of the technical proposal in this application implementation in the light of the attached drawings in this application implementation. Obviously, the implementation described is only a part of this application implementation, but not all of them. Based on the implementations in this application, all other implementations obtained by ordinary technical personnel in this field without performing creative work fall within the scope of this application.

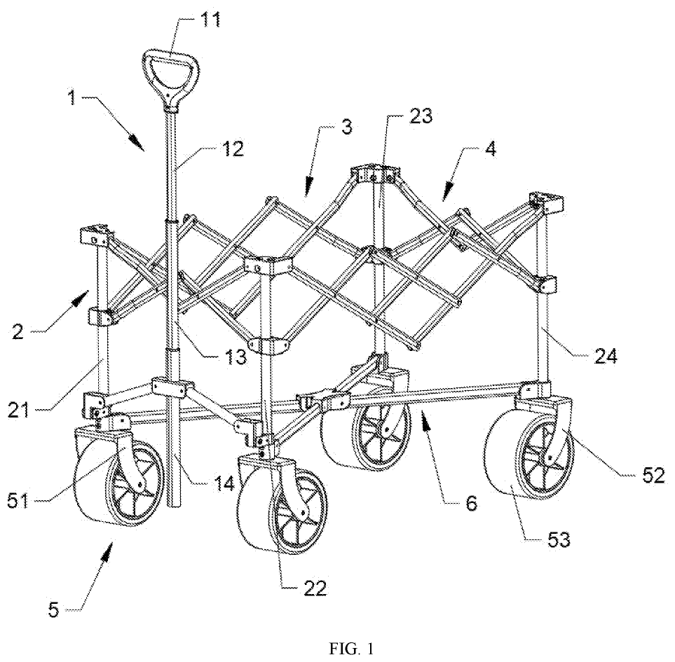

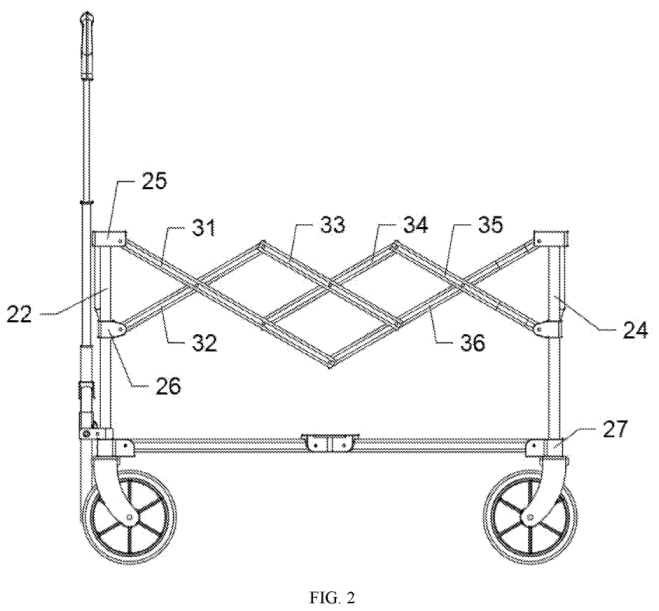

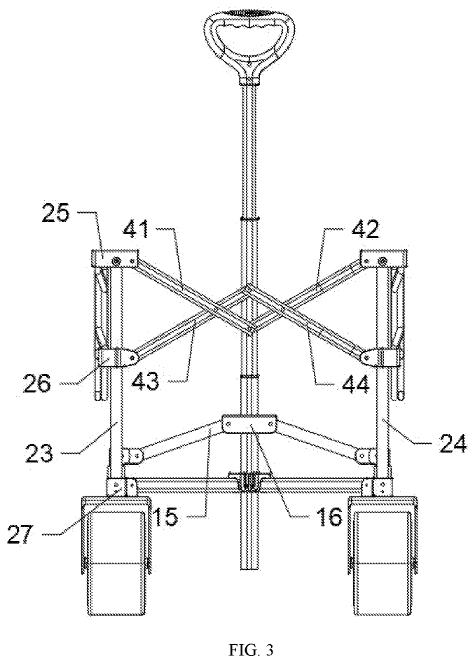

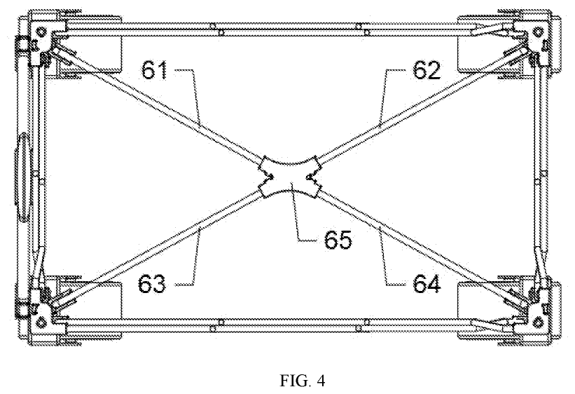

Please refer to FIGS. 1 to 4, this application provides a technical proposal: a folding trailer, including a stand-up Rod Assembly 2, the vertical rod assembly 2 is composed of a first fixed vertical pipe 21, a second fixed vertical pipe 22, a third fixed vertical pipe 23 and a fourth fixed vertical pipe 24, wherein the top of the four vertical pipes are all fixed with a top angle fixing piece 25, each of the four vertical pipes is provided with a sliding sleeve 26 connected with the sliding sleeve 26, the bottom of each of the four vertical pipes is fixed with a bottom angle fixing piece 27, and a handle assembly 1 is arranged between the first fixed vertical pipe 21 and the second fixed vertical pipe 22, the handle Assembly 1 comprises a handle 11, a first telescopic cylinder 12, a second telescopic cylinder 13 and a third telescopic cylinder 14 from top to bottom, wherein the handle 11 is fixed on the top of the first telescopic cylinder 12, the first telescopic barrel 12 is sleeved in the second telescopic barrel 13, the second telescopic barrel 13 is sleeved in the third telescopic barrel 14, and the third telescopic barrel 14 is externally fixed with a telescopic sleeve 15, both ends of the shrink sleeve 15 are provided with a fixed rod sleeve 16 connected with the shrink sleeve 15 through a rotating shaft, one end of the two fixing rod sleeves 16 away from the shrink sleeve 15 is connected with the bottom angle fixing piece 27 at the bottom of the first fixing vertical pipe 21 and the second fixing vertical pipe 22 by a rotating shaft, respectively, the bottoms of the four standpipes are further provided with a wheel assembly 5, which comprises four wheels 53, the wheel 53 at the bottom of the first and second fixed vertical pipes 21 and 22 are provided with a universal wheel fork 51 fixed at the bottom of the two vertical pipes 51, a wheel 53 at the bottom of the third fixed riser 23 and a wheel 53 at the bottom of the fourth fixed riser 24 is provided with a directional wheel fork 52 fixed at the bottom of the two risers 52, a left and right folding assembly 3 is arranged between the second and the fourth fixed vertical pipes 22 and between the first and the third fixed vertical pipes 21 and 23, respectively, the left-right Folding Assembly 3 is composed of a first cross tube 31, a second cross tube 32, a third cross tube 33, a fourth cross tube 34, a fifth cross tube 35 and a sixth cross tube 36, wherein, the connection relationship between the six crossing tubes between the second fixing vertical tube 22 and the fourth fixing vertical tube 24 is that the left side of the first crossing tube 31 is connected with the top angle fixing member 25 on the top of the second fixing vertical tube 22 by a rotating shaft; The right side of the sixth crossing tube 36 is connected with the top angle fixing member 25 on the top of the fourth fixing vertical tube 24 by a rotating shaft, the left side of the second cross tube 32 is connected with the linkage sliding sleeve 26 outside the second fixed vertical tube 22 by a rotating shaft, and the right side of the second cross tube 32 is connected with the linkage sliding sleeve 26 outside the fourth fixed vertical tube 24 by a rotating shaft, the right side of the first crossing tube 31 is connected with the left side of the sixth crossing tube 36 by a rotating shaft, and the middle third of the first crossing tube 31 is connected with the middle half of the second crossing tube 32 by a rotating shaft; The middle half of the fifth crossing tube 35 is connected with the middle third of the sixth crossing tube 36 by a rotating shaft, and the right side of the second crossing tube 32 is connected with the left side of the third crossing tube 33 by a rotating shaft; The left side of the fifth crossing tube 35 is connected to the right side of the fourth crossing tube 34 by a rotating shaft, and the middle section of the third crossing tube 33 and the middle section of the fourth crossing tube 34 are connected by a rotating shaft; The right side of the third crossing tube 33 is connected to the middle two-thirds of the sixth crossing tube 36 by a rotating shaft, and the left side of the fourth crossing tube 34 is connected to the middle two-thirds of the first crossing tube 31 by a rotating shaft, the connection mode of the left and right folding component 3 between the first fixed vertical pipe 21 and the third fixed vertical pipe 23 is in the same way as the above connection mode, a front and rear folding component 4 is arranged between the third fixed standpipe 23 and the fourth fixed standpipe 24, the front and rear folding assembly 4 comprises a first cross bend tube 41, a first cross straight tube 42, a second cross bend tube 43 and a second cross straight tube 44, wherein, the left side of the first cross bend tube 41 is connected with the top angle fixing member 25 on the top of the third fixing vertical tube 23 by a rotating shaft, the right side of the first crossing straight tube 42 is connected with the top angle fixing member 25 on the top of the fourth fixing vertical tube 24 by a rotating shaft, the left side of the second cross bend tube 43 is connected with the linkage sliding sleeve 26 outside the third fixed vertical tube 23 by a rotating shaft, and the right side of the second cross straight tube 44 is connected with the linkage sliding sleeve 26 outside the fourth fixed vertical tube 24 by a rotating shaft, the right side of the first crossover elbow 41 is connected to the left side of the first crossover straightaway 42 by a rotating shaft, and the right side of the second crossover elbow 43 and the left side of the second crossover straightaway 44 are connected by a rotating shaft; Two-thirds of the middle section of the first Cross Bend 41 and two-thirds of the middle section of the second Cross Bend 43 are connected by a rotating shaft, two-thirds of the middle section of the first crossing straight tube 42 and two-thirds of the middle section of the second crossing straight tube 44 are connected by a rotating shaft, and a bottom support component 6 is arranged at the bottom of the vertical rod component 2, the bottom support assembly 6 is formed by crossing a first bottom connecting pipe 61, a second bottom connecting pipe 62, a third bottom connecting pipe 63 and a fourth bottom connecting pipe 64, the cross center of the four bottom connecting pipes is provided with a bottom connecting piece 65 which is respectively connected with the four bottom connecting pipes through a rotating shaft, wherein, the right side of the first bottom connecting pipe 61 and the right side of the third bottom connecting pipe 63 are connected to the left side of the bottom connecting piece 65 by a rotating shaft, the left side of the second bottom connector 62 and the left side of the fourth bottom connector 64 are connected to the right side of the bottom connector 65 by a rotating shaft, the left side of the first bottom connecting pipe 61 is connected with the bottom angle fixing member 27 at the bottom of the first fixing vertical pipe 21 through a rotating shaft, the left side of the third bottom connecting pipe 63 is connected with the bottom angle fixing piece 27 at the bottom of the second fixing vertical pipe 22 through a rotating shaft, the right side of the second bottom connecting pipe 62 is connected with the bottom angle fixing piece 27 at the bottom of the third fixing vertical pipe 23 through a rotating shaft, the right side of the fourth bottom connecting pipe 64 is connected with the bottom angle fixing piece 27 at the bottom of the fourth fixing vertical pipe 24 through a rotating shaft.

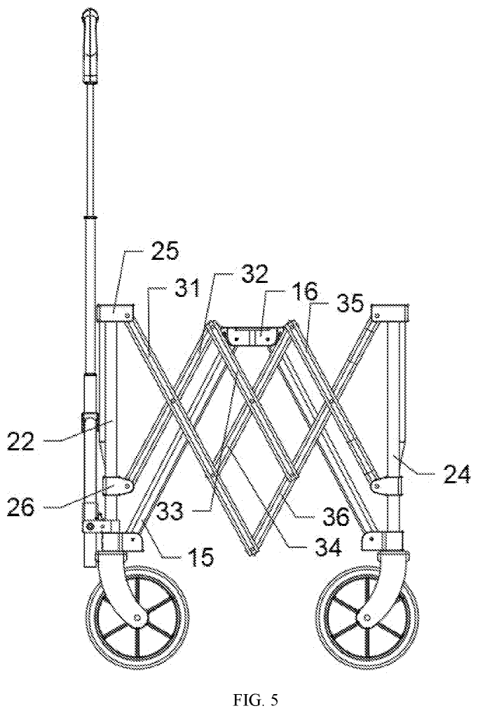

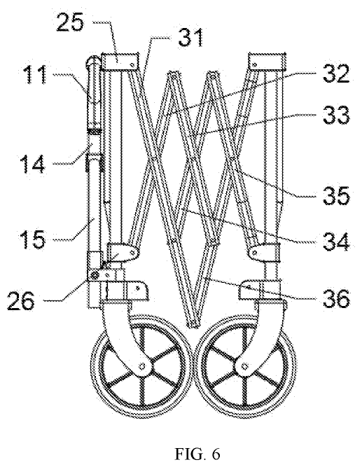

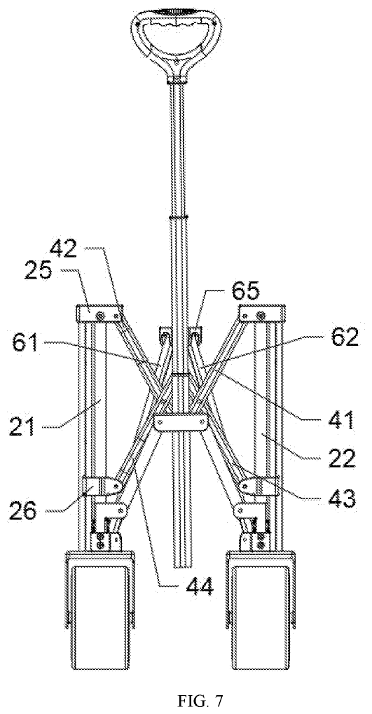

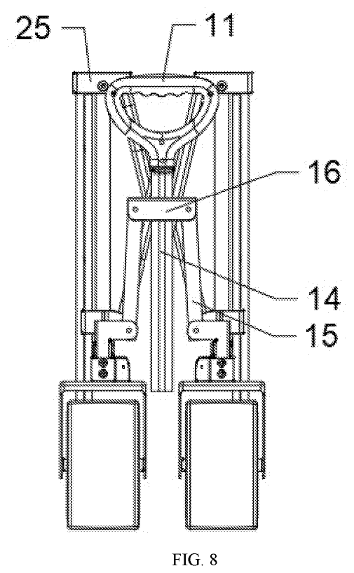

Please refer to FIGS. 5 to 8 for the principles of the folding process for this application. The folding trailer first pulls the bottom attachment 65 upward when folding, the side of the first bottom connecting pipe 61, the second bottom connecting pipe 62, the third bottom connecting pipe 63 and the fourth bottom connecting pipe 64 near the bottom connecting piece 65 rises synchronously with the bottom connecting piece 65, while the first bottom connecting pipe 61, the second bottom connecting pipe 62, the third bottom connecting pipe 63 and the fourth bottom connecting pipe 64 are far away from the bottom connecting pipe 65 and are closed to the direction of the bottom connecting pipe 65, at this time, the angle below the first crossing tube 31 and the second fixing riser 22, the angle below the sixth crossing tube 36 and the fourth fixing riser 24, the angle above the second crossing tube 32 and the second fixing riser 22, the angle above the fourth fixing riser 24, the angle above the first crossing tube 31 and the sixth crossing tube 36, the angle below the second crossing tube 32 and the third crossing tube 33, the angle below the fourth crossing tube 34 and the fifth crossing tube 35, decrease, the angles on both sides of the first crossing tube 31 and the second crossing tube 32, on both sides of the third crossing tube 33 and the fourth crossing tube 34, on the right of the fourth crossing tube 34 and the second crossing tube 32, on the left of the third crossing tube 33 and the sixth crossing tube 36, and on both sides of the fifth crossing tube 35 and the sixth crossing tube 36, are increased, moreover, the second cross-tube 32 drives down the linkage slide sleeve 26 outside the second fixed vertical tube 22, and the fifth cross-tube 35 drives down the linkage slide sleeve 26 outside the fourth fixed vertical tube 24, the folding and shrinking process of the left-right folding component 3 is completed, the included angle below the first Cross Bend 41 and the third fixed vertical pipe 23, the included angle below the first cross straight pipe 42 and the fourth fixed vertical pipe 24, the included angle above the second Cross Bend 43 and the third fixed vertical pipe 23, the included angle above the second cross straight pipe 44 and the fourth fixed vertical pipe 24, the included angle between the first Cross Bend 41 and the first cross straight pipe 42, the included angle between the second Cross Bend 43 and the second cross straight pipe 44 are reduced, the angle on both sides of the first Cross Bend 41 and the second Cross Bend 43, the angle on both sides of the first cross straight tube 42 and the second cross straight tube 44 are increased, and, the right side of the second cross bend pipe 43 drives the linkage slide sleeve 26 down outside the third fixed vertical pipe 23, and the left side of the second cross straight pipe 44 drives the linkage slide sleeve 26 down outside the fourth fixed vertical pipe 24, the folding and shrinking process of the front and back folding component 4 is completed, and finally, the right side of the shrinking sleeve 15 outside the third fixing vertical pipe 23 and the left side of the shrinking sleeve 15 outside the fourth fixing vertical pipe 24 push the fixing rod sleeve 16 up, pressing down the handle 11, the first telescopic barrel 12 is retracted into the second telescopic barrel 13 and the second telescopic barrel 13 is retracted into the third telescopic barrel 14, thereby completing the entire folding process of the folding trailer, four linkage slip sleeves 26 are lowered synchronously, and the intersection of the second CROSSOCK32 and the third Crossock33 and the intersection of the fourth Crossock34 and the fifth crossock35 are lowered, the intersection of the second Crossock43 and the second Crossock44 also moves downwards; The highest point of the constricted second crossovers 32, the third crossovers 33, the fourth crossovers 34, and the fifth crossovers 35 is flush with the horizontal line of the vertex-angle fastener 25, the height does not rise after the contraction, and the contraction process is convenient and rapid, and can be completed by a single person.

Finally, it should be noted that the above is only a preferred example of this application and is not intended to limit this application, although the application is described in detail in the light of the aforementioned example, for technical personnel in this field, it may still modify the technical scheme documented in the aforementioned implementations or replace some of the technical features of the same. Any modifications, substitutions, improvements, etc. made within the spirit and principles of this application shall be covered by this application.

1. The utility model relates to a compact folding trailer featuring that the utility model comprises a standing rod assembly (2) comprising a first fixed vertical pipe (21), a second fixed vertical pipe (22), a third fixed vertical pipe (23) and a fourth fixed vertical pipe (24), the vertical rod assembly (2) also comprises a top angle fixing member (25) which is respectively fixed on the top of four vertical pipes and a linkage sliding sleeve (26) which is gliding connected with four vertical rods respectively;
A left and right folding assembly (3) is arranged between the said second and fourth fixed vertical pipes (22) and between the first and third fixed vertical pipes (21 and 23), the first and second fixed vertical pipes (21) and the third and fourth fixed vertical pipes (24) are provided with front and back folding components (4);
The left and right folding assembly (3) comprises a first side cross tube (31) and a sixth side cross tube (36) rotationally matched with the top angle fixing member (25), respectively, the left-right folding assembly (3) also comprises a second cross tube (32) and a fifth cross tube (35) rotationally matched with the linkage sliding sleeve (26), respectively, the left-right folding assembly (3) also comprises a third cross tube (33) and a fourth cross tube (34) rotationally matched with a first cross tube (31) and a sixth cross tube (36), respectively;
The front and rear folding assemblies (4) include a first cross elbow (41) and a first cross straight pipe (42), which are rotationally matched with the top angle fixing member (25), respectively, the front and rear folding assembly (4) also comprises a second cross bend pipe (43) and a second cross straight pipe (44) rotationally matched with the linkage sliding sleeve (26), respectively.

2. A folding trailer according to claim 1, featuring that, the first side crossing tube (31) is connected with the second side crossing tube (32), the fourth side crossing tube (34) and the sixth side crossing tube (36) respectively by a rotating shaft, the second crossing tube (32) and the third crossing tube (33) are connected by a rotating shaft, and the third crossing tube (33) and the sixth crossing tube (36) are connected by a rotating shaft, the fourth cross tube (34) and the fifth cross tube (35) are connected by a rotating shaft, and the fifth cross tube (35) and the sixth cross tube (36) are connected by a rotating shaft.

3. A folding trailer according to claim 1, featuring that the first cross bend (41) and the second Cross Bend (43) are connected by a rotating shaft, the first cross straight pipe (42) and the second cross straight pipe (44) are connected by a rotating shaft, and the first cross straight pipe (41) and the first cross straight pipe (42) are connected by a rotating shaft, the second cross elbow (43) and the second cross straight pipe (44) are connected by a rotating shaft.

4. A folding trailer according to claim 1, featuring that the rod assembly (2) also comprises a bottom angle fixing member (27) which is respectively fixed at the bottom of four vertical pipes, the bottom of the rod assembly (2) is provided with a bottom support assembly (6), the bottom supporting assembly (6) comprises a first bottom connecting pipe (61), a second bottom connecting pipe (62), a third bottom connecting pipe (63) and a fourth bottom connecting pipe (64) in an X-shape respectively and rotationally matched with the four bottom corner fixing pieces (27), the cross center of the first bottom connecting pipe (61), the second bottom connecting pipe (62), the third bottom connecting pipe (63) and the fourth bottom connecting pipe (64) is also provided with a bottom connecting piece (65) which is rotationally matched with the four bottom connecting pipes respectively.

5. A folding trailer according to claim 1, featuring that a handle assembly (1) is also arranged between the first fixed vertical pipe (21) and the second fixed vertical pipe (22), the handle assembly (1) includes a shrink sleeve (15) at the bottom of the first and second fixed risers (21 and 22), respectively. The shrink sleeve (15) is provided with two and intersects each other, a fixed rod sleeve (16) which is rotationally matched with the two contractible bushings (15) is arranged at the cross center of the two contractible bushings (16), and a third telescopic cylinder (14) is fixed at the center of the fixed rod sleeve (16), the third telescopic cylinder (14) is provided with a second telescopic cylinder (13) on top of which a first telescopic cylinder (12) is fitted, a handle (11) is fixed on the top of the first telescopic cylinder (12).

6. A folding trailer according to claim 1, featuring that a wheel assembly (5) is arranged at the bottom of the rod assembly (2), the wheel assembly (5) comprises a wheel (53) at the bottom of the first fixed riser (21), the second fixed riser (22), the third fixed riser (23) and the fourth fixed riser (24), respectively, the wheels (53) at the bottom of the first and second fixed vertical pipes (21) and the joint of the two vertical pipes are respectively provided with a universal wheel fork (51), the wheels (53) at the bottom of the third and fourth fixed vertical tubes (23) and the joint of the two vertical tubes are respectively provided with a directional fork (52).

7. A folding trailer according to claim 4, featuring that when the fold-up trailer shrinks, the bottom attachment (65) rises, the side of the first bottom connecting pipe (61), the second bottom connecting pipe (62), the third bottom connecting pipe (63) and the fourth bottom connecting pipe (64) near the bottom connecting piece (65) rises with the bottom connecting piece (65), one side of the first bottom connecting pipe (61), the second bottom connecting pipe (62), the third bottom connecting pipe (63) and the fourth bottom connecting pipe (64) near the bottom angle fixing piece (27) is closed to the direction of the bottom connecting piece (65).

8. A folding trailer according to claim 2, featuring that when the folding trailer shrinks, four of the linkage sliding sleeves (26) simultaneously descend, the included angles on both sides of the first crossing tube (31) and the second crossing tube (32) and the included angles on both sides of the fifth crossing tube (35) and the sixth crossing tube (36) are increased, the angle between the lower ends of the second crossing tube (32) and the third crossing tube (33) and the angle between the fourth crossing tube (34) and the fifth crossing tube (35) are reduced, the included angle of the lower ends of the third and fourth crossing tubes (33) and the included angle of the upper ends of the first and sixth crossing tubes (31 and 36) are reduced.

9. A folding trailer according to claim 3, featuring that when the fold-up trailer shrinks, the included angles on both sides of the first cross bend tube (41) and the second cross bend tube (43) and the included angles on both sides of the first cross straight tube (42) and the second cross straight tube (44) are increased, the included angle of the lower end of the first Cross Bend (41) and the first cross straight tube (42) and the included angle of the upper end of the second cross bend (43) and the second cross straight tube (44) are reduced.

10. A folding trailer according to claim 6, featuring that when the folding trailer shrinks, the fixed rod sleeve (16) rises and the angle between the lower ends of the two shrinking sleeves (15) decreases.
